(19) United States
(12) Patent Application Publication
(10) Pub. No.: US 2013/0144814 A1
(43) Pub. Date: Jun. 6, 2013

(54) CONDITIONAL PROBABILITY OPERATOR FOR EVENT PROCESSING SYSTEMS

(71) Applicants: Doina L. Klinger, Winchester (GB); John J. P. McNamara, Winchester (GB); Erhan Mengusoglu, Southampton (GB); Mark N. Walters, Oxfordshire (GB); Xiaoming Zhang, Eastleigh (GB)

(72) Inventors: Doina L. Klinger, Winchester (GB); John J. P. McNamara, Winchester (GB); Erhan Mengusoglu, Southampton (GB); Mark N. Walters, Oxfordshire (GB); Xiaoming Zhang, Eastleigh (GB)

(73) Assignee: International Business Machines Corporation, Armonk, NY (US)

(21) Appl. No.: 13/310,826

(22) Filed: Dec. 5, 2011

(51) Int. Cl. G06N 5/02; G06F 15/18

(52) U.S. Cl. 706/12; 706/47

(57) ABSTRACT

An event processing system in which a computer receives an input event comprising one or more factors. The computer evaluates the factors of the input event based on an event processing rule containing a pattern detection operator and a conditional probability operator. The conditional probability operator can operate to calculate a conditional probability for a set of training data that a specified pattern will appear in the factors of an input event given a specified output event, and can further operate to assign a conditional rule value a binary value based on how the conditional probability compares to a target probability.

### FIELD OF THE INVENTION

The present invention relates generally to event processing systems, and more particularly to event processing rules in such systems.

### BACKGROUND

An event processing system (EPS) is a computer-based system that accepts input events derived from real-world and computer based events. The EPS processes the input event data to detect patterns in the data based on a set of event processing rules. The EPS then produces and transmits output events that will usually have a direct or indirect effect on the real world to assist the EPS user in achieving a desired goal.

An event is something that happens in the real world. An event can occur in a business context, such as a sales figure, an order being shipped, or a financial transaction. Events can occur in other contexts as well. For example, an event could be some occurrence in a computer, or in an industrial process, such as a temperature rising above a threshold.

Event producers produce events when something of interest occurs. For example, an event producer could be a temperature sensor, or business system that generates an output record of a sales figure, a financial transaction, or a warehouse shipment. Some kind of interface is often required to format the raw event data into an input event usable for later processing. For example, raw data from a sensor may be formatted into a decimal value, and a timestamp and identifier added to the event.

Event processing services reside on a computer and accept input events from event producers. The input events are processed by the event processing services based on a set of rules, which typically include a condition rule statement and an action rule statement. Patterns are detected in the input events based on the condition rule statement, and an output event is generated and transmitted based on the action rule statement. For example, a simple condition rule statement might look for a specific value provided in an input event from a specific event producer, and a simple action rule statement might report that the specific value was found.

If a pattern specified in a condition rule statement is found, the input event is assigned a classification. For example, if the specified pattern is detected, a condition rule value might be assigned the value “True.” The action rule statement associated with the condition rule statement directs the event processing services to generate an output event. For example, an output event might be a simple notification that a condition has occurred, the output event might cause some direct change to a process, or the output event might be a recommendation to take some specific action based on the simultaneous occurrences of several events.

Complex event processing consists of processing many different input events derived from different real-world events. Different input events are combined to form complex events, and the complex events are processed to detect patterns in the events based on, for example, event hierarchies, and relationships between events such as temporal, causality, and membership. Output events are then generated based on the patterns detected in the complex input events.

Event consumers receive the output events transmitted by the event processing services and perform tasks in reaction to the output events. An event consumer might be a valve actuator in an industrial process, a sales manager, or a service or application in a computer. Often, an interface is required to format the output event into a form usable by the event consumer.

The above model describes a general EPS model in which events are created by event producers, processed as input events by event processing services to generate output events, which are then acted upon by event consumers. A special case is where the event producer and the event consumer are the same entity. For example, if an EPS is applied to product sales, input events consisting of sales figures generated by retail customers buying the product might result in output events that recommend a certain product discount be applied to promote more sales by the retail customers. The retail customer receives and acts upon the product discount by buying more product. Here, the retail customer is both the event producer and the event consumer.

The above describes one model of an event processing system. Numerous models offering different terminology, having finer granularity of components, or different boundaries between EPS components are also in use.

### SUMMARY

Embodiments of the present invention provide a system, method, and program product for processing events in an event processing system. A computer receives an input event comprising one or more factors. The computer evaluates the factors of the input event based on an event processing rule containing a pattern detection operator and a conditional probability operator. The computer assigns the input event a rule category based on a result of the evaluation, and then generates an output event based on the assigned rule category.

In certain embodiments, the conditional probability operator operates to calculate a conditional probability for a set of training data that a specified pattern will appear in the factors of an input event given a specified output event. The conditional probability operator can further operate to assign a conditional rule value a binary value based on how the conditional probability compares to a target probability. In other embodiments, pattern detection operator operates to detect a specified pattern in the factors of the input event and, based on whether the pattern is detected, assigns a pattern rule value a category. The pattern detection operator can further operate to assign the pattern rule value a category based on the likelihood that the specified pattern is detected in one or more of the factors of the input event. In other embodiments, the computer can filter the input events, validate the input events, aggregate the input events, or route the output events.

### BRIEF DESCRIPTION OF THE SEVERAL VIEWS OF THE DRAWINGS

FIG. 1 is a functional block diagram of an event processing system in accordance with an embodiment of the present invention.

FIG. 2 is a functional block diagram of event producers in accordance with an embodiment of the present invention.

FIG. 3 is a functional block diagram of an event processing services program in accordance with an embodiment of the present invention.

FIG. 4 is a Venn diagram illustrating an example of a conditional probability.

FIG. 5 is a functional block diagram of event consumers in accordance with an embodiment of the present invention.

FIG. 6 is a flowchart illustrating the steps of an aspect of an event processing services program in accordance with an embodiment of the present invention.

FIG. 7 is a flowchart illustrating the steps of an aspect of a rules update program in accordance with an embodiment of the present invention.

FIG. 8 is a block diagram of hardware and software within the computers of FIG. 1 in accordance with an embodiment of the present invention.

### DETAILED DESCRIPTION

Embodiments of the present invention describe event processing systems in which the condition rule statements can include conditional probability operators. In a traditional EPS, event processing rule statements might take the form:

/* Condition Rule Statement */
If (F(Input_Event)) then Rule_Value = True;
else Rule_Value = False;
//
/* Action Rule Statement */
If Rule_Value = True then output Output_Event_1;
else output Output_Event_2;

where F is a Boolean function that evaluates whether a certain pattern is found in the event data, and Rule Value is a classification value.

For classification models that allow for input events to be classified into many different categories, a traditional event processing rule might take the form:

/* Condition Statement */
If P(Input_Event) = Cat_1 then Rule_Value = 1;
else If P(Input_Event) = Cat_2 then Rule_Value = 2;
else If P(Input_Event) = Cat_3 then Rule_Value = 3;
//
/* Action Statement */
If Rule_Value = 1 then output Output_Event_1;
else If Rule_Value = 2 then output Output_Event_2;
else If Rule_Value = 3 then output Output_Event_3;

where P(Input_Event) is, for example, a multinomial logistics model representing the likelihood of a specific outcome, for example heart disease, based on values found in the input event, for example patient cholesterol level, whether patient smokes, patient weight, level of exercise, etc. The multinomial logistics model category values of Cat_{—}1, Cat_{—}2, and Cat_{—}3 might represent the different likelihoods that a patient profiled by the input event data will develop heart disease, won't develop heart disease, or is borderline. Actions 1, 2, and 3 might be lifestyle recommendations to the patient based on the likelihood that the patient will develop heart disease.

In embodiments of the present invention, condition rule statements can include a conditional probability operator in addition to the pattern detection operators just described. For example, a condition rule statement might take the form:

If (P(Input_Event)=Cat_{—}1) AND (M(Pattern_{—}1|Output_Event_{—}1)>0.8) then Rule_Value_{—}1=True; (1)

where (M(Pattern_{—}1|Output_Event_{—}1) is the conditional probability that Pattern_{—}1 will occur in an input event given Output_Event_{—}1 as an output event. The conditional probability operator is evaluated over a sample space, which typically would be the training data used to train the EPS. Using the example above, P((Input_Event) is a multinomial logistic model that categorizes an input event representing a patient's profile as likely, not likely, or borderline with regard to developing heart disease based on patient lifestyle factors included in the input data. As an example the model might indicate that the patient has a high likelihood of developing heart disease and output a value of Cat_{—}1. The cardiologist decides that lowering cholesterol levels is the best course of action for the patient and wants to identify those treatments that have the best chance of accomplishing this goal. For patients with different health conditions, physical attributes and lifestyle choices, different treatment options will be more or less effective in causing a change in the patient's cholesterol levels. For example, dietary changes will be more effective for some patients, whereas exercise or a drug regimen may be more effective for others. Conditional probability operator M(Pattern_{—}1|Output_Event_{—}1) can be used to indicate the success of various treatment options. For example, Pattern_{—}1 might be the modified input record for the patient with the cholesterol levels reduced. Output_Event_{—}1 might be a recommendation for a specific treatment option, for example recommending to the patient to change his or her diet. The conditional probability operator can be used to indicate the predicted success of lowering a patient's cholesterol levels based on a recommendation to the patient to change the diet for patients having similar health conditions, physical attributes and lifestyle choices based on records in the training data. Condition rule (1) above can be read as follows: if the likelihood of this particular patient developing heart disease is high based on the patient's health conditions, physical attributes and lifestyle choices, and the probability is over 80% that similarly situated patients will end up with reduced cholesterol levels if they are given a recommendation to change their diets, then set a rule value to True. Thus, EPS rules programmers can write rules in terms of the probability that certain events will occur if a specific output event is generated.

Embodiments of the present invention will now be described in detail with reference to the accompanying drawings.

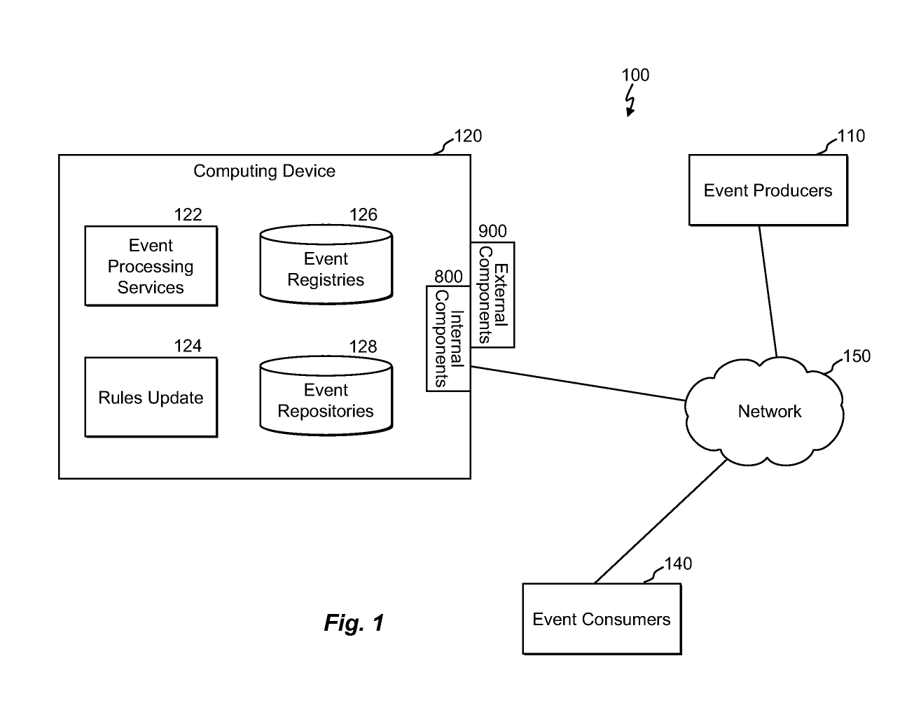

FIG. 1 is a functional block diagram illustrating an event processing system 100 in accordance with an embodiment of the present invention. Event processing system 100 includes event producers 110, a computing device 120, and event consumers 140, all interconnected over a network 150.

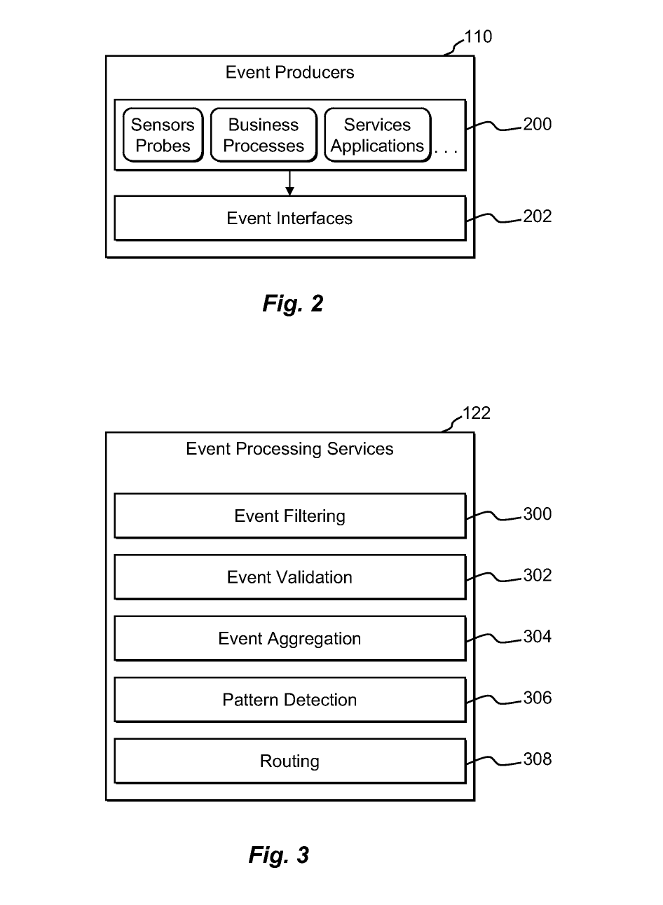

FIG. 2 is a functional block diagram of event producers 110 in accordance with an embodiment of the present invention. Event producers 110 include producing agents 200 and event interfaces 202. Producing agents 200 are devices, processes, services, applications, etc., that produce input events. In general, producing agents 200 can be any device, process, etc., that generates an event of interest. As illustrated, examples of producing agents can include sensors and probes to measure or detect physical properties such as heat, light, sound, pressure, speed, magnetic flux, voltage, chemicals, etc. Producing agents 200 might include business processes that produce, for example, orders, sales figures, shipments, budget numbers, employee demographics, etc. Producing agents 200 might also include services and applications that run on a computer and produce, for example, notifications of hardware errors or packet failures, etc.

Producing agents 200 do not always produce input events in the format desired by downstream entities. Event interfaces 202 receives input events from producing agents 200 and formats the input events into the desired output formats. For example, input events from sensors and probes might be formatted into decimal format and a timestamp added. Event interfaces 202 might also do processing, such as filtering and aggregation. In a preferred embodiment, event interfaces 202 route input events to event processing services program 122. In general, event interfaces 202 perform formatting functions on input events as necessary, and route the input events to the desired destinations. Each input event could be formatted differently for different destinations, and each input event could be routed to multiple destinations.

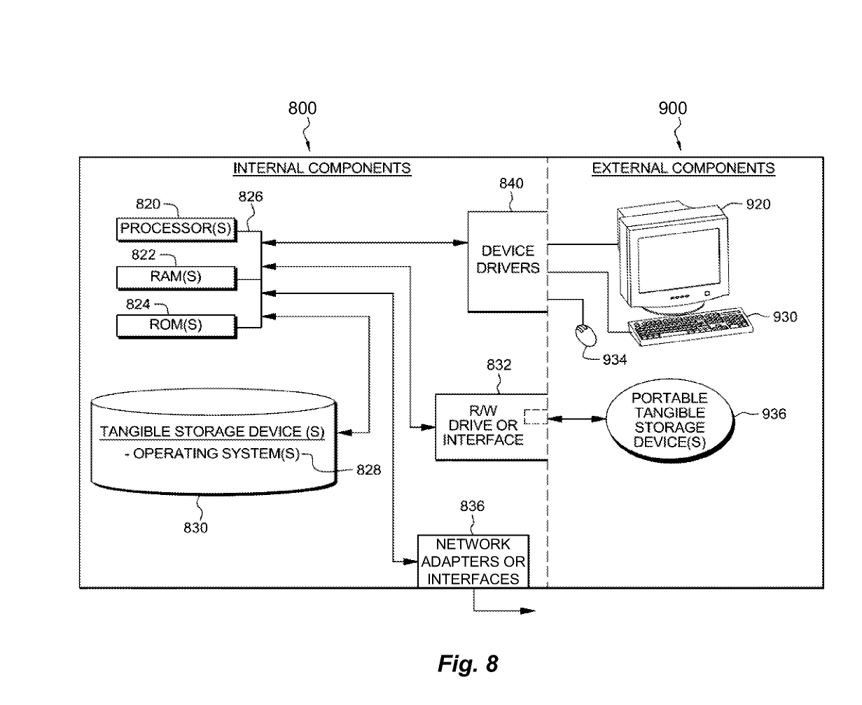

In a preferred embodiment, computing device 120 includes event processing services program 122, rules update program 124, event registries 126, and event repositories 128. Computing device 120 also includes internal hardware components 800 and external hardware components 900. In preferred embodiments of the present invention, computing device 120 can be a laptop, tablet, or netbook personal computer, a desktop computer, a mainframe or mini computer, a personal digital assistant (PDA) such as a Blackberry (R), or a smart phone. In general, computing device 120 can be any programmable electronic device as described in further detail with respect to FIG. 8.

FIG. 3 is a functional block diagram of the event processing services program 122 in accordance with an embodiment of the present invention. Event processing services program 122 receives the input events generated by event producers 110. In a preferred embodiment, event processing services program 122 includes event filtering module 300, event validation module 302, event aggregation module 304, pattern detection module 306, and routing module 308.

Event filtering module 300 receives input events from event producers 110 and performs a filtering function on the received input events to accept only those input events that will be processed by pattern detection module 306. Event validation module 302 receives the input events passed by filtering module 300 to confirm that the information contained in the input events is valid. For example, event validation module 302 might confirm that numeric fields in an input event record are within the specified range, that a Boolean True/False field contains either a “True” or a “False,” etc. Event filtering module 300 and event validation module 302 make use of event registries 126, which contain information on known input event types, record layouts, valid field values and ranges, etc.

Event aggregation module 304 operates to group information from input events. For example, pattern detection module 306 might process information relating to the start and stop times of an event. Event aggregation module 304 uses event repositories 128 to store the event start time input event, and then combine the start time information with the event stop time from the associated event stop time input event. This aggregated information is then sent to pattern detection module 306. In another example, event processing services program 122 processes a certain input event type based on input event occurrences during a fixed time interval. Event aggregation module 304 stores the relevant input events in event repositories 128 over the time interval, and aggregates the results for pattern detection module 306 to process.

Pattern detection module 306 processes input events sent by event filtering module 300, event validation module 302, and event aggregation module 304. In general, the input events are complex and will include values, which might be aggregated, for several different individual events that have occurred. Thus, an input event typically has the form of a record with several fields, each field corresponding to an individual event or event type. The input events are processed in accordance with a set of rules, which may include one or more condition rule statements and action rule statements. A condition rule statement instructs pattern detection module 306 what to look for in the input events and how the input events should be classified. Table 1 shows an example of a condition rule in pseudo-code in accordance with one embodiment. In the example, four patterns in the input events are tested. The third condition statement includes a conditional probability operator, in addition to a pattern detection operator, that tests the probability of Pattern 1 occurring in a training data input event if the output event is Output_Event_{—}1. A Boolean variable Rule_{—}1_Value is set to True or False depending on whether a condition rule statement is satisfied. In this example, the condition rule is an ordered list of condition tests, and the input event is classified based on the first condition test that is satisfied. A default value for Rule_{—}1_Value is set by the last statement in the rule. This default value is applied if none of the condition rule statements are satisfied. In general, pattern detection module 306 can perform either simple or complex event processing.

TABLE 1
/* Condition Rule 1 */
If ((Pattern_1) AND (Pattern_2)) then Rule_1_Value = True;
else if ((Pattern_2) AND (Pattern_3)) then Rule_1_Value = False;
else if (Pattern_4) AND (M(Pattern_1 | Output_Event_1) > 0.8)
then Rule_1_Value = True;
else Rule_1_Value = True;

An action rule statement instructs pattern detection module 306 what action to take based on the results of the condition rule statements. The action to take depends on the nature of the EPS and can range from a simple notification to the appropriate person or system, to causing, for example, a valve to close in an industrial process. Table 2 shows an example action rule in pseudo-code.

TABLE 2

```
/* Action Rule */
If (Rule_1_Value) = True
    then output Output_Event_1
    else output Output_Event_2;
```

As stated above, in one embodiment, the condition rules classify the input events as a Boolean value, indicating a higher or lower likelihood of a correct classification based on the training data and relative to the overall input event stream. For example, the classification might be whether a patient will develop heart disease and the condition rule value is either True or False. The input event might comprise various factors having numeric, Yes/No, and category values relating to the patient's lifestyle, such as cholesterol level, whether the patient smokes, etc. The training data might consist of thousands of patient records that include the various values relating to patients' lifestyles, what actions were taken by the cardiologist, follow-up values for the event factors to record the effect of the cardiologists' actions, and whether and when in fact the patient developed heart disease.

In a traditional event processing system, the training data might be modeled using a binomial logistic regression model. For example, the probability of developing heart disease based on the above input factors can be determined by using a logistic function having the form:

$$f ( z ) = \frac{1}{1 + {e}^{- z}} \qquad ( 2 )$$

The variable z is usually defined as:

z=β₀+β₁χ₁+β₂χ₂+β₃χ₃+ . . . +β₁χₖ (3)

where β₀ is the y-intercept, and β₁, β₂, β₃, etc., are the regression coefficients of factors χ₁, χ₂, χ₃, etc. As applied to the example, factors χ₁, χ₂, χ₃, etc., would include the various numeric, Yes/No, and category values (expressed as number values) relating to the patient's lifestyle, such as cholesterol level, whether the patient smokes, etc. The regression coefficients β₁, β₂, β₃, etc., in equation (3) would be the relative positive and negative weightings for the factors, representing the factor's importance, and whether the factor's effect is to increase or decrease the probability of the patient developing heart disease. The y-intercept value β₀ is the default probability of developing heart disease if none of the factors come into play. As can be seen from equation (2), f(z) will always be between 0 and 1. Based on the probability f(z), the binomial logistic regression model might categorize an input event in one of two categories—likely or not likely to develop heart disease.

In practice, a statistical modeling package such as the IBM SPSS Modeler version 14.2 is typically used to perform the binomial logistic regression model. IBM and SPSS are registered trademarks of International Business Machines Corporation. Using the training data, the user identifies heart disease as the target value, and all other factors as input values. The binomial logistic regression model within the IBM SPSS Modeler analyzes the training data and calculates the regression coefficient values. After the model is trained, a patient's input record is input to the model, and the model indicates whether the patient is likely to develop heart disease. Based on this likelihood and, for example, various values for the factors in the patient input record, the user programs a rule to cause the model to provide, for example, recommendations as to lifestyle changes to reduce the likelihood of developing heart disease. In this example, the IBM SPSS Modeler is acting as an event processing system.

In embodiments of the invention, a conditional probability operator is introduced that can be included in the EPS rule set along with condition detection operators. Conditional probability can be represented by the following equation:

$$P ( A \vert B ) = \frac{P ( A ⋂ B )}{P ( B )} \qquad ( 4 )$$

Equation (4) can be stated as: the conditional probability of A given B is the quotient of the joint probability of A and B, and the marginal probability of B. The conditional probability is evaluated over a sample space.

From the example above, an event processing rule based on condition rule (1) can be written as:

| | |
|---|---|
| /* Condition Rule */ | (5) |

If (P(patient will develop heart disease) = True) AND
(M(patient cholesterol levels will drop | patient told to change diet) > 0.8)
then Rule_Value_1 = True;
//
/* Action Rule */
If Rule_Value_1 = True
then output (make recommendation to change diet);

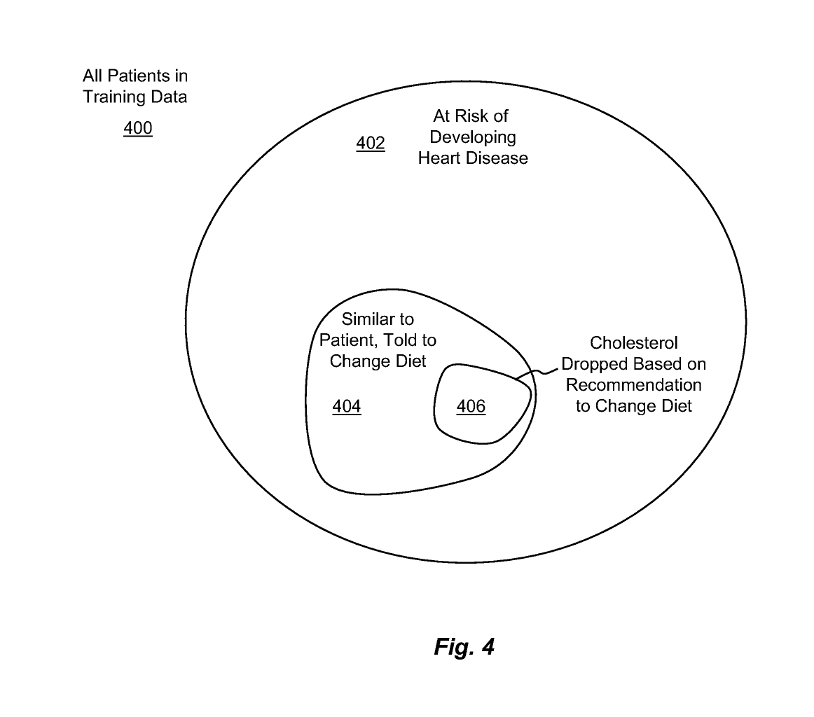

FIG. 4 is a Venn diagram illustrating how the conditional probability operator in event processing rule (5) might be visually evaluated. The large area 400 represents all of the patients in the training data. Area 402 represents the patients who the EPS would indicate as being at risk of developing heart disease. Area 404 represents those patients who are similarly situated to the patient of interest, and to whom a recommendation to change diet was given. Area 406 represents those patients who are similarly situated to the patient of interest and who actually saw decreased cholesterol levels based on a recommendation to change their diets. As can be seen from the diagram, not all patients similarly situated to the patient of interest who received a recommendation from their cardiologist to change their diets did in fact see reduced cholesterol levels. Applying equation (4) to rule (5) and the Venn diagram of FIG. 4, the conditional probability operator is evaluated as the percentage of area 404 that area 406 represents. A quick visual inspection of the Venn diagram seems to show that the conditional probability operator in rule (5) is not greater than 80%, assuming that the Venn diagram is drawn approximately to a representative scale. Therefore, Rule_Value_{—}1 is not set to True, and the output event resulting from the action rule portion of rule (5) is to not simply make a recommendation to the patient of interest to change their diet.

In practice, a statistical modeling package, such as the IBM SPSS Statistics version 20, would typically be called to evaluate a conditional probability operator in an EPS rule. For example, the training data could be segmented according to the input event data factors of interest. Depending on the types of factors included in the input event data, the segmentation might be accomplished by simple pattern matching, or might require a predictive model, such as a binomial or multinomial logistic regression model, all of which are available in the IBM SPSS Statistics package. After the data is segmented, the conditional probability operator might be evaluated by using, for example, the Crosstabs function within the IBM SPSS Statistics package. If the input event factors are more complex, they might be evaluated with the aid of the binomial or multinomial logistic regression functions in the IBM SPSS Statistics package.

Rules update module 124 is invoked periodically to update or refine the EPS rules. EPS rule sets are often refined to improve their performance in driving behaviors of interest. For example, changes in conditions may cause changes in the relative importance of the factors that influence the behaviors of interest. In another example, there may not have been sufficient training data to which to apply a statistical analysis for certain new factors or output events. In these cases, for example, a regression analysis could be run on a recent set of training data to refine the relative weightings of the various factors. Based on these new weightings and other factors, such as, for example, strategic business directions, the EPS rules can be refined to produce a better and more current set of output events to attempt to drive the behavior of interest in a desired direction. Typically, training data comprises output events, including the factors that the EPS rule used to produce the output event. Additional factors that may have an influence on the behavior of interest can also be included in the training data records for later statistical analysis. If possible, the actual effect on the behavior of interest is also included.

In a preferred embodiment, the training data comprising input events including all input factors, the corresponding output actions, and the effects of the output actions are processed through a statistical modeling package, such as IBM SPSS Modeler version 14.2. Using IBM SPSS Modeler version 14.2, all factors included in the training data are defined as “input” type fields, and the rule output value is defined as a “target” type field. The input fields are further defined as to the type of field, such as continuous value, integer, Boolean, etc. The training data is then analyzed using, for example, the Binomial or Multinomial Logistic Regression models. The Modeler will generate a refined set of rules to more accurately classify the input events. While an embodiment using IBM SPSS Modeler is described, there are many other statistical modeling packages available in the marketplace that can also be used.

Routing module 308 directs the output events to the appropriate event consumers 140 via network 150. Different output events may be directed to different event consumers, and an event output may be directed to multiple event consumers.

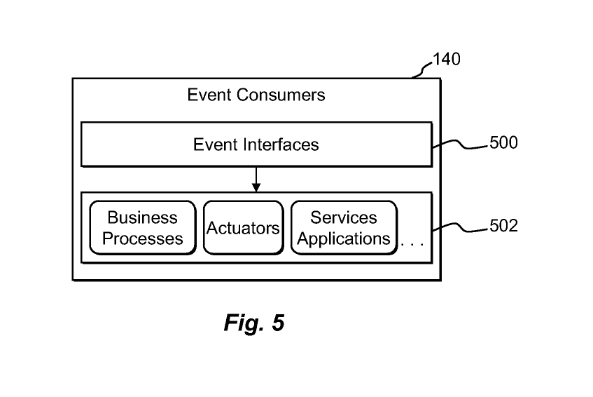

FIG. 5 is a functional block diagram of event consumers 140 in accordance with an embodiment of the present invention. Event consumers 140 include event consumer agents 502 and event interfaces 500. Event consumer agents 502 perform tasks in reaction to receiving an output event. Similar to producing agents 200, event consumer agents 502 are devices, processes, services, applications, etc., that react to output events received from event processing services program 122. In general, event consumer agents 502 can be any device, process, person, etc. that reacts to an output event produced by an EPS. As illustrated, event consumer agents 502 can include business processes, and actuators that control various physical devices in industrial processes, and services and applications that run on a computer.

Event processing services program 122 does not always produce output events in the format desired by event consumer agents 502. Event interfaces 500 receive output events from event processing services program 122 and format the output events into the desired formats. For example, event processing services program 122 might transmit certain output events in a common format to all event consumers 140. Event interfaces 400 would, for example, format the output events in accordance to the specific requirements for each event consumer agent 402. Event interfaces 500 might also do some modest processing, such as filtering and aggregation. In the preferred embodiment, event interfaces 500 route output events to the proper event consumer agent 502. In general, event interfaces 500 perform formatting functions on output events as necessary, and route the output events to the proper event consumer agent. Each output event could be formatted differently for different event consumer agents, and each output event could be routed to multiple event consumer agents.

Network 150 interconnects event producers 110, computing device 120, and event consumers 140. Network 150 can be, for example, a local area network (LAN), a wide area network (WAN) such as the Internet, or a combination of the two, and include wired, wireless, or fiber optic connections. In general, network 150 can be any combination of connections and protocols that will support communications between event producers 110, computing device 120, and event consumers 140 in accordance with a desired embodiment of the invention.

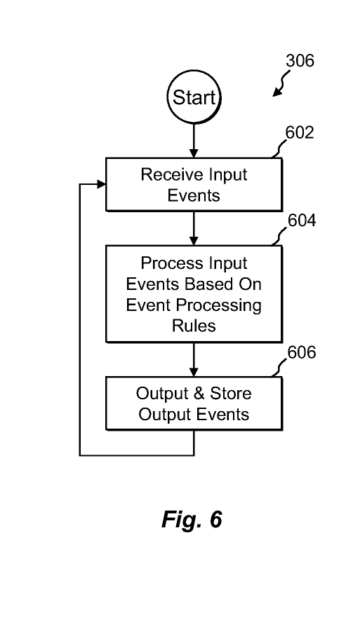

FIG. 6 is a flowchart illustrating the general steps performed by pattern detection module 306 of event processing services program 122 in accordance with an embodiment of the present invention. Pattern detection module 306 receives input events that are passed by event filtering module 300, event validation module 302, and event aggregation module 304 (step 602).

Each input event is then processed in accordance with a set of rules (step 604) that detect patterns in the input events, and classify the input events as a Boolean value. An output event is then generated based on the classification of the input event. The output event is then sent (step 606) to routing module 308 for transmission to event consumers 140 via network 150. The output event is also stored in event repositories 128 for later use, for example as training data to refine the rules used by Pattern detection module 306. After an output event is generated and sent (step 606), pattern detection module awaits the next input event (step 602).

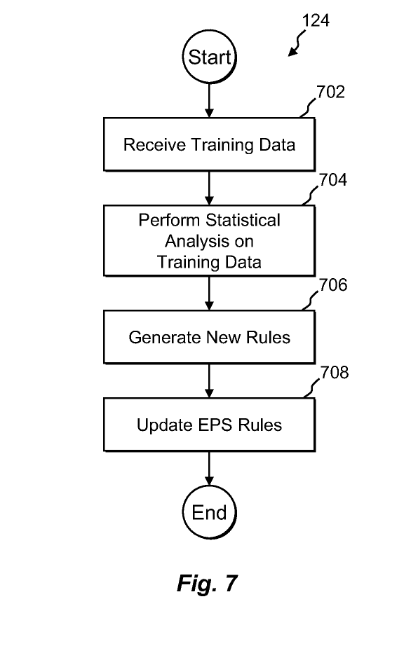

FIG. 7 is a flowchart illustrating the general steps performed by rules update module 124 in accordance with an embodiment of the present invention. After a period of time a training set is collected that comprises a statistically significant number of output events in which the EPS rule set has caused the output event to have an incorrect Boolean classification value. That is, a process external to the EPS determines that the rule set has in fact incorrectly classified the input event and produced either a false-positive or false-negative classification value in the output event. The training data records comprise output events, including the factors that the EPS rule used to produce the output event. If possible, the actual effect on the behavior of interest is also included. The training records are processed by rules update module 124 at step 702. A separate statistical analysis is performed on the false-negative training records and the false-positive training records (step 704) to identify underlying patterns in the factors of the two sets of records. As described above in relation to rules update module 124, a statistical modeling package, such as IBM SPSS Modeler version 14.2 can be used to perform the analysis and generate a new rule set. Based on the statistical analysis, a new pair of EPS rules is generated—one each for the two sets of records (step 706). The EPS rule set is then updated with the new rule pair (step 708).

FIG. 8 shows a block diagram of the components of a data processing system 800, 900, such as computing device 120, in accordance with an illustrative embodiment of the present invention. It should be appreciated that FIG. 8 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed systems and cloud computing environments that include any of the above systems or devices.

Computing device 120 includes internal components 800 and external components 900 illustrated in FIG. 8. Internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs 122 and 124 in computing device 120 are stored on one or more of the computer-readable tangible storage devices 830 for execution by one or more of the processors 820 via one or more of the RAMs 822 (which can include cache memory). Event registries 126 and event repositories 128 are also stored on one or more of the computer-readable tangible storage devices 830. In the embodiment illustrated in FIG. 8, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also includes a read/write drive or interface 832 to read from and write to one or more portable computer-readable tangible storage devices 936 such as a CD-ROM, DVD, memory stick, magnetic tape, magnetic disk, optical disk or semiconductor storage device. The programs 122 and 124 in computing device 120 can be stored on one or more of the portable computer-readable tangible storage devices 936, read via the respective R/W drive or interface 832 and loaded into the respective hard drive 830.

Internal components 800 also includes network adapters or interfaces 836 such as a TCP/IP adapter cards, wireless wi-fi interface cards, or 3G or 4G wireless interface cards or other wired or wireless communication links. The programs 122 and 124 in computing device 120 can be downloaded to user computer 120 from an external computer via a network (for example, the Internet, a local area network or other, wide area network) and network adapters or interfaces 836. From the network adapters or interfaces 836, the programs 122 and 124 in computing device 120 are loaded into the hard drive 830. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A method for processing events, the method comprising the steps of:
a computer receiving an input event comprising one or more factors;
the computer evaluating the factors of the input event based on an event processing rule containing a pattern detection operator and a conditional probability operator;
the computer assigning a rule category to the input event based on a result of the evaluation; and
the computer generating an output event based on the assigned rule category.

2. A method in accordance with claim 1, wherein the conditional probability operator operates to calculate a conditional probability for a set of training data that a specified pattern will appear in the factors of an input event given a specified output event.

3. A method in accordance with claim 2, wherein the conditional probability operator further operates to assign a binary value to a conditional rule value based on how the conditional probability compares to a target probability.

4. A method in accordance with claim 1, wherein the pattern detection operator operates to detect a specified pattern in the factors of the input event and, based on whether the pattern is detected, assigns a pattern rule value a category.

5. A method in accordance with claim 4, wherein the pattern detection operator further operates to assign the pattern rule value a category based on the likelihood that the specified pattern is detected in one or more of the factors of the input event.

6. A method in accordance with claim 1, further comprising the steps of:
the computer filtering the input events;
the computer validating the input events;
the computer aggregating the input events; and
the computer routing the output events.

7. A computer program product to process events, the computer program product comprising:
one or more computer-readable storage devices and program instructions stored on at least one of the one or more tangible storage devices, the program instructions comprising:
program instructions to cause a computer to receive an input event comprising one or more factors;
program instructions to evaluate the factors of the input event based on an event processing rule containing a pattern detection operator and a conditional probability operator;
program instructions to assign the input event a rule category based on a result of the evaluation; and
program instructions to generate an output event based on the assigned rule category.

8. A computer program product in accordance with claim 7, wherein the conditional probability operator further comprises program instructions to calculate a conditional probability for a set of training data that a specified pattern will appear in the factors of an input event given a specified output event.

9. A computer program product in accordance with claim 8, wherein the conditional probability operator further comprises program instructions to assign a conditional rule value a binary value based on how the conditional probability compares to a target probability.

10. A computer program product in accordance with claim 7, wherein the pattern detection operator further comprises program instructions to detect a specified pattern in the factors of the input event and, based on whether the pattern is detected, assigns a pattern rule value a category.

11. A computer program product in accordance with claim 10, wherein the pattern detection operator further comprises program instructions to assign the pattern rule value a category based on the likelihood that the specified pattern is detected in one or more of the factors of the input event.

12. A computer program product in accordance with claim 7, further comprising:
program instructions to filter the input events;
program instructions to validate the input events;
program instructions to aggregate the input events; and
program instructions to route the output events.

13. A computer system to process events, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to cause a computer to receive an input event comprising one or more factors;
program instructions to evaluate the factors of the input event based on an event processing rule containing a pattern detection operator and a conditional probability operator;
program instructions to assign the input event a rule category based on a result of the evaluation; and
program instructions to generate an output event based on the assigned rule category.

14. A computer system in accordance with claim 13, wherein the conditional probability operator further comprises program instructions to calculate a conditional probability for a set of training data that a specified pattern will appear in the factors of an input event given a specified output event.

15. A computer system in accordance with claim 14, wherein the conditional probability operator further comprises program instructions to assign a conditional rule value a binary value based on how the conditional probability compares to a target probability.

16. A computer system in accordance with claim 13, wherein the pattern detection operator further comprises program instructions to detect a specified pattern in the factors of the input event and, based on whether the pattern is detected, assigns a pattern rule value a category.

17. A computer system in accordance with claim 16, wherein the pattern detection operator further comprises program instructions to assign the pattern rule value a category based on the likelihood that the specified pattern is detected in one or more of the factors of the input event.

18. A computer system in accordance with claim 13, further comprising:
program instructions to filter the input events;
program instructions to validate the input events;
program instructions to aggregate the input events; and
program instructions to route the output events.
